(19) United States
(12) Patent Application Publication
(10) Pub. No.: US 2024/0378267 A1
(43) Pub. Date: Nov. 14, 2024

(54) A SYSTEM AND METHOD FOR REALTIME JS ACCESS CONTROL TO DOM/APIS

(71) Applicant: Forter Ltd, New York, NY (US)

(72) Inventor: Ori Argov, Tel Aviv (IL)

(21) Appl. No.: 18/684,594

(22) PCT Filed: Aug. 17, 2022
(86) PCT No.: PCT/US2022/040569

§ 371 Date: Feb. 16, 2024

Related U.S. Application Data
(60) Provisional application No. 63/235,324, filed on Aug. 20, 2021.
(60) Provisional application No. 63/235,337, filed on Aug. 20, 2021.

(51) Int. Cl. G06F 21/12; G06F 21/64

(52) U.S. Cl. CPC G06F 21/121; G06F 21/64

(57) ABSTRACT

The system can be configured to execute a subset of “hooks” or “proxies,” to manage IS, DOM, or API execution. The subset of hooks or proxies are associated with known data access operations, known functions, etc., that target system accesses representing vulnerability or data accesses for sensitive information. For example, the subset leverage options available in conventional browsers to secure control as the system cannot recompile the end-user's browser in a real-time site scenario, nor force an extension installation. In such on-line environments, the system is configured to employ IS level proxies/hooks, that can be delivered, for example, by a IS tag, inline code, or a server-side templating solution. Based on execution of the real-time permission and access control, for example, via the IS level proxies/hooks, various embodiments are configured to provide real time alerts and restrictions on third party IS code, DOM requests, and APIs.

### RELATED APPLICATION

This application claims priority under 35 U.S.C. § 119 to U.S. Provisional Application Ser. No. 63/235,324, filed Aug. 20, 2021, entitled “SYSTEM AND METHOD FOR CONTROLLING JS SCRIPTS ACCESS TO DOM/APIS” which is incorporated herein by reference in its entirety, and claims priority under 35 U.S.C. § 119 to U.S. Provisional Application Ser. No. 63/235,337, filed Aug. 20, 2021, entitled “A SYSTEM AND METHOD FOR REALTIME JS ACCESS CONTROL TO DOM/APIS”, each of which is incorporated herein by reference in their entirety.

### BACKGROUND

Web browsers represent a high value target for malicious actors because sensitive data passes or is accessed and becomes available through them. Web browsers can be used for almost any online activity, including casual shopping, enterprise management, banking, even military operation or communication. Web browsers have become the primary vehicle people use to access network-connected systems. Browsers have a long history of vulnerabilities that have provided attackers with a lucrative and near-endless supply exploits.

### SUMMARY

In many conventional systems, JavaScript (JS) and the browser have very limited APIs and controls over permissions and access to the document object model “DOM” and browser APIs. In contrast, mobile applications software development kits (“sdks”) and frameworks include permissions to APIs that play a role in ensuring user data security and privacy, the JS in the browser is currently very limited in this aspect.

Various aspects of the present disclosure, resolve this by integrating new functionality that enables improved data security and privacy and/or based on new architecture that enhances security and privacy when executing browsers. Further aspects enable a system to provide discovery, validation and ultimately control over candidate scripts (JS) that any website wishes to include. According to one embodiment, the system is configured to manage browser execution in any online environment. For example, in settings where browsers cannot be controlled, including typical on-line usage, the management system can still improve security and improve operation in terms of data privacy and web site provider preference (e.g., users). Various embodiments achieve these improvements even in the settings where script providers refuse to share underlying code and/or obscure underlying operation in order to protect their software. The online capability can be implemented as an extension of offline security features where a secure execution environment is available and can be leveraged to ensure valid, secure, and policy compliant execution.

According to some embodiments, offline implementation can be modelled in online setting as a real-time permission and access control system. According to various embodiments, the system can be configured to execute a subset of “hooks” or “proxies,” where the subset is known and verified to be safe to run for a live production website. The subset of hooks or proxies are associated with known data access operations, known functions, etc. that target system accesses that represent vulnerability or can target data accesses that request sensitive information, or request information a user wishes to prevent (e.g., any data scraping from forms, etc.). For example, the subset can be based on possible options available in conventional browsers as the system cannot recompile the end-user's browser in a real-time site scenario, and also cannot force a browser extension installation in typical settings. While such options may be available in an offline mode or secure execution environment, they cannot be relied on to secure execution in on-line settings. In such on-line environments, the system is configured to employ JS level proxies/hooks, that can be delivered, for example, by a JS tag or a server-side templating solution. Based on execution of the real-time permission and access control, for example, via the JS level proxies/hooks, various embodiments are configured to provide real time alerts and restrictions on third party JS code.

According to one aspect, a system for managing script execution by a browser. The system comprises at least one processor, a memory operatively coupled to the at least one processor, he at least one processor when executing configured to instantiate a browser session to include a proxy layer configured to manage interaction with the browser and secured functions called by third party operations, wherein the secured functions are configured to run as part of a website's code presented in the browser, monitor execution of the secured functions, verify valid execution of the secured functions, prevent execution of the secured functions by the browser or browser functionality responsive to failed verification, permit execution of the secured functions by the browser or browser functionality responsive to verification.

According to one embodiment, the at least one processor is configured to instantiate a cache layer to manage resource requests made by the browser, any script executed by the browser, and any application programming interface. According to one embodiment, the at least one processor is further configured to allocate cache resources based on a mapping of the requests made by the browser, any script executed by the browser, and any application programming interface to the resources. According to one embodiment, the mapping of the requests is generated in a test environment modeling operations of the browser, any script executed by the browser, and any application programming interface interacting with the browser.

According to one embodiment, the at least one processor is further configured to allocate the cache resources based on a mapping of the requests made by the browser and a system defined budget for the mapped resources. According to one embodiment, the at least one processor is configured to limit execution of the browser or browser functionality to the secured functions. According to one embodiment, the at least one process is configured to access policy constraints defining parameters of the valid execution. According to one embodiment, the parameters are defined by at least one of default constraints, user specified constraints, budgeted constraints, or certification of validity constraints. According to one embodiment, the at least one processor is configured to execute inline code or script tags upon accessing a website to instantiate the proxy layer.

According to one embodiment, the proxy layer includes a set of proxy objects configured to manage execution of third party function requests by the browser. According to one embodiment, the third party function requests include at least one of javascript request, document object model (DOM) request, or application programming interface (API) requests. According to one embodiment, the at least one processor is configured to access any one or more of a default specification of the set of proxy objects, a user defined specification of the set of proxy objects, or an enhanced verification specification of the set of proxy objects. According to one embodiment, the at least one processor is configured to trigger enhanced verification responsive to identifying unexpected operation or unexpected access. According to one embodiment, the at least one processor is configured to access an enhanced verification specification defining at least one of additional proxy objects, updated functionality for any one or combination of respective ones of the set of proxy objects, or additional analysis of access requests. According to one embodiment, the at least one processor is configured to validate a third party function based on a validity signature of the third party function. According to one embodiment, the at least one processor is configured to allow or deny execution of the third party function in response to validity analysis of the signature.

According to one aspect, a computer implemented method for managing script execution by a browser is provided. The method comprises instantiating, by at least one processor, a browser session, the act of instantiating including establishing a proxy layer configured to manage interaction with the browser and secured functions called by third party operations, wherein the secured functions are configured to run as part of a website's code presented in the browser, monitoring, by the at least one processor, execution of the secured functions, verifying, by the at least one processor, valid execution of the secured functions, preventing, by the at least one processor, execution of the secured functions by the browser or browser functionality responsive to failed verification, and permitting, by the at least one processor, execution of the secured functions by the browser or browser functionality responsive to verification.

According to one embodiment, the method further comprises executing, by the at least one processor, inline code or script tags upon accessing a website to instantiate the proxy layer. According to one embodiment, the method further comprises generating, by the at least one processor, a set of proxy objects included in the proxy layer, wherein the proxy objects are configured to manage execution of third party function requests by the browser. According to one embodiment, the third party function requests include at least one of javascript request, document object model (DOM) request, or application programming interface (API) requests, and method further comprises managing, by the at least one processor, execution of the at least one of javascript requests, document object model (DOM) request, or application programming interface (API) requests through respective poxy objects. According to one embodiment, the method further comprises accessing, by the at least one processor, any one or more of a default specification of the set of proxy objects, a user defined specification of the set of proxy objects, or an enhanced verification specification of the set of proxy objects.

According to one aspect, a system for managing script execution by a browser, the system comprises at least one processor, memory operatively coupled to the at least one processor, the at least one processor when executing configured to instantiate a sandboxed environment including at least a proxy layer for managing resource requests, execute the browser within the sandboxed environment and respective site code, capture information on any resource requests made by the browser, validate operation and any resource requests based on a system defined security or privacy policy, and generate a secure signature for the browser and/or script or a validation log of the resource requests made by the browser, responsive to validation of operation.

According to one embodiment, the system is further configured to generate a secure signature for scripts under test responsive to validation of operation. According to one embodiment, the system is further configured to generate a secure signature for the browser responsive to validation of operation. According to one embodiment, the at least one processor is further configured to evaluate any access points targeted, resource requested, communication calls, operating system requests, privilege change, memory requests inconsistent with prior operation, as specified by the security or the privacy policy. According to one embodiment, the at least one processor is further configured to evaluate any access points targeted, resource requested, communication calls, operating system requests, privilege change, memory requests inconsistent with prior operation, as defined by default system parameters.

According to one embodiment, at least one processor is configured to obscure any operations executed under the management of the proxy layer. According to one embodiment, the at least one processor is configured to return results of new operations in the site code based on specification in any original code of the new operations. According to one embodiment, the at least one processor is configured to analyze any code associated with a new operation in associated site code based on known vulnerability exploits and custom execution targets (e.g., customized based on the script being analyzed). According to one embodiment, the proxy layer is further configured to manage execution of any operations performed by the site code based on javascript, document object model (“DOM”) specification, network operations. According to one embodiment, the at least one processor is configured to analyze new operations in the site code using similarity to historic operations, including similarity to access points, DOM element access, operating system calls, and network requests.

According to one aspect, a computer implemented method for managing script execution by a browser, the method comprising, instantiating, by the at least one processor, e a sandboxed environment including at least a proxy layer for managing resource requests, executing, by the at least one processor, the browser within the sandboxed environment and respective site code, capturing, by the at least one processor, information on any resource requests made by the browser, validating, by the at least one processor, operation and any resource requests based on a system defined security or privacy policy, and generating, by the at least one processor, a secure signature for the browser and/or script or a validation log of the resource requests made by the browser, responsive to validation of operation.

According to one embodiment, the method further comprises generating a secure signature for scripts under test responsive to validation of operation. According to one embodiment, the method further comprises generating a secure signature for the browser responsive to validation of operation. According to one embodiment, the method further comprises evaluating any access points targeted, resource requested, communication calls, operating system requests, privilege change, memory requests inconsistent with prior operation, as specified by the security or the privacy policy. According to one embodiment, the method further comprises evaluating any access points targeted, resource requested, communication calls, operating system requests, privilege change, memory requests inconsistent with prior operation, as defined by default system parameters.

According to one embodiment, the method further comprises obscuring any operations executed under the management of the proxy layer. According to one embodiment, the method further comprises returning results of new operations in the site code based on specification in any original code of the new operations. According to one embodiment, the method further comprises analyzing any code associated with a new operation in associated site code based on known vulnerability exploits and custom execution targets (e.g., customized based on the script being analyzed). According to one embodiment, the method further comprises managing execution of any operations performed by the site code based on javascript, document object model (“DOM”) specification, and network operations. According to one embodiment, the method further comprises analyzing new operations in the site code using similarity to historic operations, including similarity to any one of: access points, DOM element access, operating system calls, or network requests.

According to one aspect, a system for managing script execution by a browser is provided. The system comprises at least one processor; a memory operatively coupled to the at least one processor; the at least one processor when executing configured to: instantiate a sandboxed environment including at least a proxy layer for managing resource requests; execute the browser within the sandboxed environment and respective site code; access validation information associated with the browser and respective scripts; verify the browser and respective script against the validation information; prevent execution of the browser or browser functionality responsive to failed verification; and permit execution of the browser or browser functionality response to verification.

Still other aspects, embodiments, and advantages of these exemplary aspects and embodiments, are discussed in detail below. Any embodiment disclosed herein may be combined with any other embodiment in any manner consistent with at least one of the objects, aims, and needs disclosed herein, and references to “an embodiment,” “some embodiments.” “an alternate embodiment.” “various embodiments,” “one embodiment” or the like are not necessarily mutually exclusive and are intended to indicate that a particular feature, structure, or characteristic described in connection with the embodiment may be included in at least one embodiment. The appearances of such terms herein are not necessarily all referring to the same embodiment. The accompanying drawings are included to provide illustration and a further understanding of the various aspects and embodiments, and are incorporated in and constitute a part of this specification. The drawings, together with the remainder of the specification, serve to explain principles and operations of the described and claimed aspects and embodiments.

### BRIEF DESCRIPTION OF THE DRAWINGS

Various aspects of at least one embodiment are discussed herein with reference to the accompanying figures, which are not intended to be drawn to scale. The figures are included to provide illustration and a further understanding of the various aspects and embodiments, and are incorporated in and constitute a part of this specification, but are not intended as a definition of the limits of the invention. Where technical features in the figures, detailed description or any claim are followed by reference signs, the reference signs have been included for the sole purpose of increasing the intelligibility of the figures, detailed description, and/or claims. Accordingly, neither the reference signs nor their absence are intended to have any limiting effect on the scope of any claim elements. In the figures, each identical or nearly identical component that is illustrated in various figures is represented by a like numeral. For purposes of clarity, not every component may be labeled in every figure. In the figures:

FIG. 1 is a block diagram of a management system and flow, according to one embodiment;

FIG. 2 is a block diagram of an example special purpose computer system improved by the functions and/or processes disclosed herein;

FIG. 3 is a block diagram of an example system and flow, according to one embodiment;

FIG. 4 is a block diagram of a management system, according to one embodiment;

FIG. 5 is a block diagram of an example system and flow, according to one embodiment;

FIG. 6 is a block diagram of an example system and flow, according to one embodiment.

### DETAILED DESCRIPTION

According to one aspect, ensuring valid and/or secure extension of scripts in browser setting can be improved over offline approaches described herein to enable integration into an online setting. For example, offline approaches can also be modeled as a real-time permission and access control system that can be used to manage more common unsecure browser environments. According to some embodiments, the system can be configured to execute a subset of “hooks” or “proxies,” where the subset is known and verified to be safe to run for a live production website (e.g., the system has performed a rigorous verification of the performance correctness/side-effects and stealth of this layer). For example, using a JS Proxy Object is not detectable as such by code calling this object. In various embodiments, the system is configured to request the proxy object as early as possible, to avoid unvalidated code from taking precedence over the proxied operation.

According to one embodiment, the subset is based on possible options available in conventional browsers (e.g., the system cannot recompile the end-user's browser in a real-time site scenario, and typically cannot force a browser extension installation). In further embodiments, these operations can be requested as part of an initial load of a website or included in-line at the beginning of coded operation. In on-line environments, the system is configured to employ JS level proxies/hooks, that can be delivered, for example, by a JS tag or a server-side templating solution. According to one embodiment, the initial code can be delivered by an inline JS tag code embedded in the main html page. Embedding the tag code in the main html so that it executes as early as possible can ensure loading (and setting proxies) as fast as possible, where the first scripts loaded have precedence. Other example can use operations to download JS resources, and further examples can combine the approaches. In further embodiments, once the code in the main html (“seed” code) is executed, the code is configured to pull-in the full JS code and settings that allow the most robust solution. If the “seed” code detects that the main code is blocked from loading, or fails to download from alternate bypassing methods, the initial code can be configured to signal an unsafe condition. For example, the seed code can use a JS event and/or a global hidden/encrypted variable and/or localStorage value and/or cookie etc., among other options to detect and/or notify of the unsafe condition. In further embodiments, the unsafe condition can be used to determine that the current execution is not protected enough, and enable functionality on the respective site (or administration) to decide what to do in this context (for example, a site can show a pop-up saying “please disable any traffic blocker to continue”). Accordingly, various embodiments enable real time alerts and restrictions on third party JS code, for example, based on execution of the real-time permission and access control.

Examples of the methods, devices, and systems discussed herein are not limited in application to the details of construction and the arrangement of components set forth in the following description or illustrated in the accompanying drawings. The methods and systems are capable of implementation in other embodiments and of being practiced or of being carried out in various ways. Examples of specific implementations are provided herein for illustrative purposes only and are not intended to be limiting. In particular, acts, components, elements, and features discussed in connection with any one or more examples are not intended to be excluded from a similar role in any other examples.

Also, the phraseology and terminology used herein is for the purpose of description and should not be regarded as limiting. Any references to examples, embodiments, components, elements or acts of the systems and methods herein referred to in the singular may also embrace embodiments including a plurality, and any references in plural to any embodiment, component, element, or act herein may also embrace embodiments including only a singularity. References in the singular or plural form are not intended to limit the presently disclosed systems or methods, their components, acts, or elements. The use herein of “including,” “comprising.” “having.” “containing,” “involving.” and variations thereof is meant to encompass the items listed thereafter and equivalents thereof as well as additional items. References to “or” may be construed as inclusive so that any terms described using “or” may indicate any of a single, more than one, and all of the described terms.

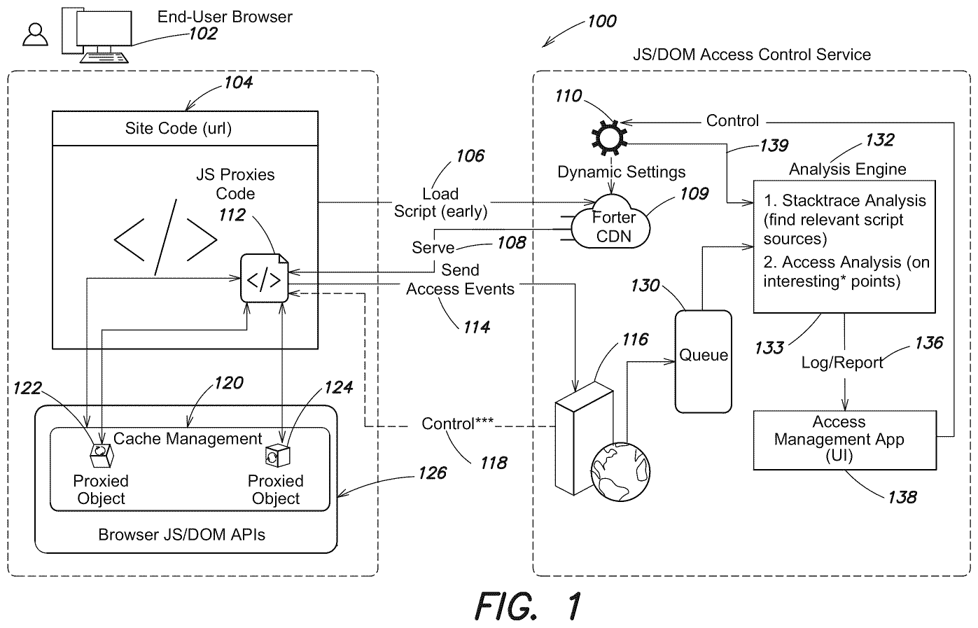

FIG. 1 is a block diagram of an example system and flow 100 that enables secure execution of browser functions (e.g., JS, extensions, APIs., etc.) in a “live” environment. As shown in FIG. 1 an end user browser 102 can access a website and associated site code 104. In some embodiments, the site code can include seed code (e.g., a JavaScript tag) in the main HTML code. For example, the seed code can include a script tag included in the header portion of the HTML to ensure that the scripts are loaded early (e.g., 106). The seed code can be used to download or access (e.g., 108) full proxied code that manages valid/secure operation of an online or unaltered browser.

According to various embodiments, the system executes proxied code to pass a relevant subset of intercepted calls for analysis. The subset of intercepted calls can be specified in the dynamic settings 110. In some examples, the system includes a default subset based on known functions, data targets, operations, among other examples, that represent security vulnerabilities and or data privacy issues. In further embodiments, how the system operates with respect to the subset can be specified in the seed code and/or completely specified by the full script code.

According to some embodiments, the full script code can be hosted on a content delivery network (e.g., 109 “CDN”). The operation and specifics of the full code can be defined dynamically via the dynamic settings 110. The dynamic settings can include system default settings which specify targets, functions, or data access points that can be monitored by default. The dynamic settings can also include user-defined targets, functions, or data access points, among other options. In some examples, the user is able to override default settings with their selections. In another example, specific requests, functions, or access can trigger enhanced monitoring based on dynamic settings. In one implementation, upon detection of a BLUETOOTH access request, the system can increase monitoring on the script, DOM, or API that triggered the request (e.g., engaging stack trace analysis if not already active, increasing the frequency or degree of monitoring if already active, etc.). In various embodiments, the system includes some presets on which the system collects stack traces (e.g., sensitive API's, among other options). In addition to the list of sensitive APIs the user can define and add their own. In one examples, the user may specify that a set of five API's are critical. The system is configured to accept those setting and perform extra analysis/monitoring as specified.

Returning to the site code 104, proxied code can be executed as part of the website operation for example at 112. The proxy code can send access events to a control server 116 which can be used to block access to specific functions, APIs, enforce budget constraints, configure cache options, etc., at 118.

According to some embodiments, proxied execution can be coupled with cache management where script requests for data access are directed by the proxy objects to a cache management layer 120. The cache management layer 120 represents a known valid data repository with known contents. Thus, any data access that uses the cache layer can be constrained to valid requests regardless of what function, API, or script requests data. In further embodiments, use of the cache management layer ensures valid data flow even in unsecured or online browser environments. Various proxy objects shown by way of example at 122 and 124 can be linked to various browser JS, DOM requests, or APIs (e.g., 126), functions, or scripts among other options to ensure valid data exchange/access is occurring regardless of the code being used in the respective APIs, functions, or scripts.

According to some embodiments control server 116 can be configured to build a queue 130 of analysis events. The queue can be processed by an analysis engine 132 which can execute stack trace analysis on any of the queued events to find relevant script sources and/or perform access analysis on interesting access points (e.g., at 133). Interesting access points can include known access vulnerabilities, likely access points for obtaining sensitive information, and/or user-defined targets of interest to the user. At 136, a log or report of the analysis performed by the engine 132 can be surfaced and access management application or user interface at 138. The application or user interface (e.g., 138) can be the vehicle by which a user specifies their own dynamic settings which can then be used to update the analysis engine, for example, by specifying interesting access points, policy options (e.g., block function, block API, permit function but under budget, permit API but under budget, budget details, cache options, data access restrictions, etc.), data access rules and/or restrictions, among other options. Any updates in the dynamic settings 110 can be fed into the analysis engine 132 via 139.

In some embodiments, the system extends security and privacy validation even into sites not using content signing mechanisms (e.g., sub-resource integrity “SRI”). The inventors have also realized that SRI security where present can be bypassed, thus the extension into non-SRI environments provides additional layers of security even in the event of compromise of SRI.

In further embodiments, the system can employ validity stamps or signatures made on various code objects and/or browser versions to provide some measure of increased security. As discussed below, various scripts, APIs, etc., can be analyzed in a secure environment design to test valid operation (e.g., with can include any specification of security constraints, data and/or function policy, and can include options like, no data scraping, no form access, among other options).

For non-SRI or compromised environments, the system provides various methods for locking down JS access while on the site. For example, the system can include a central JS library (providing the proxies (e.g., hosted on CDN 109). In some examples, the library describes a JS tag included with the site (or server-side solution modifying served JS on the fly) which includes the proxying layer. The served JS can be modified at a CDN based on the security needs, data privacy need, and/or policy considerations of a given web-site or user. In other examples, code execution paths can be chosen based on server-side responses and server-side state. According to one embodiment, if the system detects some warning signals during execution, the server can trigger additional code, download more code or resources for more checks, triggers different reporting urls, block access to sensitive objects, among other options.

According to one embodiment, the library installs the production-safe hooks/proxies, performs analysis on the call stack when intercepting relevant access, and reports this access upstream (e.g., upstream could be JS events/calls to client code, or network calls to a service etc.). Based on proxied execution, the system is configured to detect access to any API/DOM in real-time and, for example, restrict execution and/or report for alerting and audit purposes into a dedicated endpoint. In some embodiments, a system administrator or other privileged user can specify the system behavior based on configuration settings. For example, the system administrator can specify for certain endpoint accesses a notification is triggered, while for other endpoints that system can be configured to prevent execution. In some examples, the privileged users can create security hierarchies and populate various end-points into groups, and define operations of the security features based on those groups.

In further embodiments, the system can include some conventional JS anti-tampering and debugging techniques to ensure that the proxy execution (e.g., proxy code) above is not disabled through some form of JS script attack. In one example, a conventional approach of defining a whitelist of scripts being allowed access to an API can be defined. If the system (e.g., via the proxy layer) detects unauthorized access, the system is configured to return a null response and report the abnormal use into a centralized server.

As has been demonstrated, JavaScript can be used to mount cache attacks and other malicious operations. Some approaches are available to circumvent these attacks. However, many conventional implementations focus on permissions and access and do not account for limiting execution/securing execution on other basis (e.g., based on performance limitations, among other options). Further conventional implementations describe a browser extension level as a proof of concept. Owing to the implementation, it is not optimized or in many cases not capable for use in offline analysis and does not provide security at a browser native level layer. The inventors have realized that conventional implementation does not provide for securely concealing proxied execution. For example, known conventional approaches do not try to hide themselves very well. The result is that conventional proxy approaches can easily be detected and circumvented.

Further embodiments can employ self-modifying protection within the proxy layer as well as employ self-protecting code to prevent applications or functions from identifying they are operating in a proxied environment. In some examples, the system is configured to set up the proxied environment as a first step or stage in enabling secured execution. For example, the end user browser is required to access a content server of a security provider that can be configured to set up a proxy layer used to manage subsequent functions executed in the user's browser. In other embodiments, a user can be directed to the security provider's content server and requested to start a new browser process to set up the proxied execution. According to one example, the system is configured to verify a prerequisite that the “seed” JS code tag (e.g., inline or referenced) is included in the main html page (for example in the <head> section) and that the content service provider “CSP” allows access to the security provider domains to download and execute additional JS code. In further embodiments, the server may require a confirmation or acknowledgement of installation of the proxied code.

### Example Performance Optimization (Caching)

In some embodiments, the system executes a real-time control module configured to provide enhanced security in real-time. In further embodiments, the real-time JS control module yields additional security and optimization in further contexts:
browser clients often complain about needing to include many third party JS scripts,
when a few of them access the same data and APIs (but do slightly different
processing and need their own code to run on the site).
   The impact for this requirement comes both in terms of a JS performance impact, and an impact on data access management. Many conventional approaches seek to resolve this issue by pushing JS providers into some sort of consolidation, where JS providers are limited based on the fact that they are collecting the same data to take the needed data from one or more specified sources. The inventors have realized that this approach is often not possible and/or not feasible.

Thus, various embodiments of the system couple a caching layer with the JS proxy layer to enable JS script to take data from the cache rather than forcing an arbitrary consolidation that does not work in many conventional approaches. In one embodiment, the system implements a proxy for JS and to provide caching. For example, the system executes scripts to manage an option of caching on a first request, thus allowing the system to be more efficient. In one example, the system cache enables saving resources on costly browser APIs that would normally be called over and over. In further embodiments, the system is configured to optimize performance by accessing some data in the most efficient way possible (for example, using background threads to handle common data requests while preserving the ability of a main thread (e.g., UI) to continue to run without blocking or slowing). In one example, the system can employ WebWorker threads to more efficiently provide data access in a cache layer.

### Example Governance Embodiments

In still other embodiments, the system can implement full blown JS governance. For example, the system can be configured to map out which script (vendor) is trying to access which data. The system can use the knowledge of script and data access to manage all such requests according to a system defined budget. In various examples, the system can be configured to provide “budget” controls for APIs or data, etc. The budget can define access to data such that cached data use is maximized across APIs, scripts, etc. Further, the budget can limit and/or allocate processing across various tasks, so no vendor implementation overwhelms any environment. Various budgets can be implemented where, for example, cache access has no associated cost, but a “fresh” or new request to an API or data source consumes budget resources, and thus limits a process or app to a handful or new requests (e.g., 1, 2, 3, 4, etc.).

In some environments, a web site manager can generate a security policy or security budgeting allocation. For example, the website can employ the managed access approaches disclosed to specify an allocation of access that any script provider must follow. In one example, under the access allocation access to an API may be assigned a value, a data repository request another value, access to a control function another value. Various embodiments monitor the budget and how much has been used. For example, once the aggregate value for the policy has been exceeded, subsequent request (for example, that have values assigned) can be blocked, or return errors. By managing security and privacy concerns by budget, the web site owner can increase security/data privacy of their site while given good actors the opportunity to code their scripts to accomplish what is needed (e.g., not exceed the budget).

In further embodiments, budgets can be assigned to script providers or specific scripts, and providers or scripts with greater indicia of trust (e.g., relative to other providers or scripts) can be allocated greater budgets, and the inverse can also apply—where providers or scripts with lower indicia of trust can be allocated smaller budgets.

In further embodiment, the system can build user interface displays that reflect budget constraints imposed on requests made by JS, APIs, etc., and provide visualization of how any budget (e.g., what requests) are exceeding any allocation. These feedback loops can facilitate JS, DOM, and API redesign to be more secure, less invasive, and more compliant with data privacy. In still other embodiment, the system can employ budgets and permissions, where for example, specific functions and/or specific script tags are not permitted.

In some examples, a budget constraint and/or permission constraint can be linked specific function like permitting or not a geolocation request, or assigning a high value to that operation to disfavor its use. In another example, any operation that triggers a pop up for a web site viewer can be block outright or given a high value that is measured against an operating budget. According to various embodiments, these constraint enable fine-tuned control over operations executed on a given site that improves over conventional implementation.

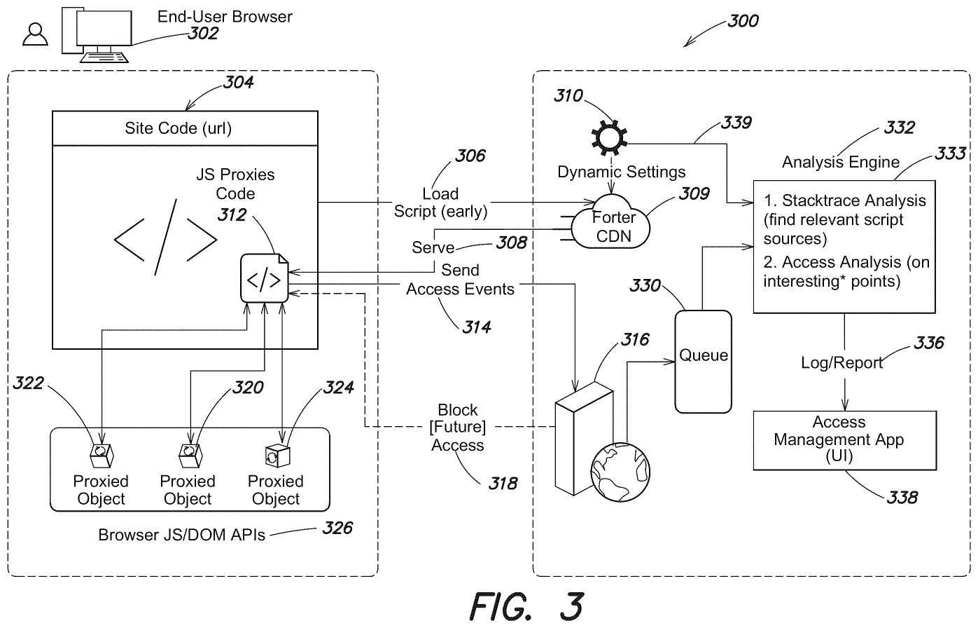

FIG. 3 is a block diagram of an example system and flow 300 that enables secure execution of browser functions (e.g., JS, extensions, APIs., etc.) in a “live” environment. As shown in FIG. 3, an end user browser 302 can access a website and associated site code 304. In some embodiments, the site code can include seed code (e.g., a JavaScript tag) in the main HTML code. For example, the seed code can include a script tag included in the header portion of the HTML to ensure that the scripts are loaded early (e.g., 306). The seed code can be used to download or access (e.g., 308) full proxied code that manages valid/secure operation of an online or unaltered browser.

According to various embodiments, the system executes proxied code to pass a relevant subset of intercepted calls for analysis. The subset of intercepted calls can be specified in the dynamic settings 330. In some examples, the system includes a default subset based on known functions, data targets, operations, among other examples, that represent security vulnerabilities and or data privacy issues. In further embodiments, how the system operates with respect to the subset can be specified in the seed code and/or completely specified by the full script code.

According to some embodiments, the full script code can be hosted on a content delivery network (e.g., 309 “CDN”). The operation and specifics of the full code can be defined dynamically via the dynamic settings 330. The dynamic settings can include system default settings which specify targets, functions, or data access points that can be monitored by default. The dynamic settings can also include user-defined targets, functions, or data access points, among other options. In some examples, the user is able to override default settings with their selections.

In some embodiments, enhanced functionality can include enhanced tracing and recording of operations being performed. For example, a web site provider may wish to approach a third party script develop with logs of operations that are not compliant or represent vulnerability and/or a data leakage. In this example, the detailed report enables the third party to correct and bad activity, or be subject to exclusion, among other options.

Returning to the site code 304, proxied code is executed as part of the website operation for example at 332. The proxy code sends access events to a control server 336 which can be used to block access to specific functions, APIs, enforce budget constraints, configure cache options, etc., at 338.

Example proxy objects shown by way of example at 320, 322, and 324 which can be linked to various browser JS, DOM requests, or APIs (e.g., 326), functions, or scripts among other options to ensure valid data exchange/access is occurring regardless of the code being used in the respective APIs, functions, or scripts.

According to some embodiments, control server 336 can be configured to build a queue 330 of analysis events. The queue can be processed by an analysis engine 332 which can execute stack trace analysis on any of the queued events to find relevant script sources and/or perform access analysis on interesting access points (e.g., at 333). Interesting access points can include known access vulnerabilities, likely access points for obtaining sensitive information, and/or user-defined targets of interest to the user. At 336, a log or report of the analysis performed by the engine 332 can be surfaced and access management application or user interface at 338. The application or user interface (e.g., 338) can be the vehicle by which a user specifies their own dynamic settings which can then be used to update the analysis engine, for example, by specifying interesting access points, policy options (e.g., block function, block API, permit function but under budget, permit API but under budget, budget details, cache options, data access restrictions, etc.), data access rules and/or restrictions, among other options. Any updates in the dynamic settings 330 can be fed into the analysis engine 332 via 339.

In some embodiments, the system extends security and privacy validation even into sites not using content signing mechanisms (e.g., sub-resource integrity “SRI”). The inventors have also realized that SRI security where present can be bypassed, thus the extension into non-SRI environments provides additional layers of security even in the event of compromise of SRI.

In further embodiments, the system can employ validity stamps or signatures made on various code objects and/or browser versions to provide some measure of increased security. As discussed below, various scripts, APIs, etc., can be analyzed in a secure environment design to test valid operation (e.g., with can include any specification of security constraints, data and/or function policy, and can include options like, no data scraping, no form access, among other options).

Shown in FIG. 3 at 306 are various script calls that are executed “early.” According to various examples, early loading of scripts (e.g., including in header portions of web-site code, among other options) is based on the knowledge that since script loading from a URL is easier to block. In various embodiments, the system is configured to initialize the proxied execution to ensure other scripts do not take precedence and/or prevent the proxied scripts/functions from loading. In some examples this can be accomplished with setup and initialization as an inline script and/or inline code in HTML. Having initial set-up in inline code or scripts provides assurance that various functional sections are loaded and protected. As discussed herein, once the initial setup has been executed, full or further configurations and code can be fetched (e.g., from the CDN).

According to another aspect, online approaches to script validation can leverage functionality and/or results from offline environments. Some offline or secure execution embodiments are described to illustrate synergies between the implementations and provide examples of implementation useful in either setting. According to some embodiments, a management system is configured to host a secure execution environment. Browser scripts and API requests can be evaluated in the secure execution environment to validate their functions in terms of security and/or data privacy. For example, once proper function has been validated in terms of data privacy and/or security, the candidate script, API, etc., can be signed as valid (e.g., via a secure hash). The secure hash can be used in subsequent operation to ensure that the script, API, etc. matches a known valid version and function. Such hashes can be used in online implementation, although additional security enhancements can be implemented to improve operation in online settings.

In further embodiments, the system is configured to validate operation via a proxy layer or hooking all of the function controls so that whenever is requested (e.g., outside resources or data), the system is configured to track what is requested and what operations are done. In this context, the system can identify any suspect, invalid, and improper activity whether the activity implicate security or data privacy concerns. For example, data access not needed in the API context would be flagged invalid. In addition, the system is configured to allow users to define specific operations or accesses that they want to allow or not allow. The system can monitor for some known subset of functions by default and augment that subset with user defined targets.

Various aspects of the disclosure describe architecture and implementation to improve the security of browser execution, including execution based on javasscript (“JS”). To provide an example context, a problem that embodiments in the disclosure address is based on a conventional website. In one example, the website can be hosted by an e-commerce merchant, where the website includes third party scripts. In this context, the merchant likely has very little knowledge or control over what the third party scripts are accessing. This leads to suspicion, lengthy security evaluation processes, tension between the need of the third party to preserve trade secrets and the website's need to protect its users (and by extension, itself).

Accordingly, various aspects enable a system to provide discovery, validation and ultimately control over candidate scripts (e.g., JS) that any website wishes to include. According to one embodiment, the system is configured to execute a sandboxed and audited environment in which browser execution can be controlled. According to various embodiments, the environment is managed so that any relevant DOM/API access is “hooked” (or “proxied”), and the hooked execution is configured to monitor the behavior of any JS script being executed by the browser. Various embodiments are configured to hook capture specific APIs and properties for exfiltration, including reporting on operations, targets, modification (attempts), discovery attempts, communication requests, etc.

Various implementations can be executed to provide the sandboxed and audited environment including various proxy based implementations. Some example proxy implementations include:
Executing modified (e.g., compiled from source) browsers—where execution by the browser is proxied on the native level (e.g., safest, possible for offline analysis). In some examples, a monitored version of the browser can be built to ensure only monitored/proxied executions are made.
   An example includes the Chromium browser, which can be specially configured to securely execute various resources, and in further embodiments to ensure that the proxied execution cannot be detected or circumvented by, for example, JS code running in the browser. Another example includes the BRAVE browser. The various browsers can be configured, for example, to disable default permissions, including DOM functionality.
   In some examples, resource execution occurs through defined proxies that specify targets and handlers, logging any requested execution(s), targets, modifications, etc. The logs can be configured to capture prior state of any modified data to ensure validity. Further examples, include prohibited targets that could be used to compromise the browser or environment. In another example, various browsers can be configured to cause all third-party network requests to be blocked by default, unless allowed by the user and proxied object.
Proxy execution of any browser extension (e.g., offline analysis and possibly online analysis)
   According to some examples, this approach involves a delivery method of the JS Proxy code (which can be expanded) to pages running in the secure environment. In one example, the system can be configured to simply inject a JS script with the logic, or in other examples, the system can be configured to stage processing including a set up stage to accomplish secure execution, which can include hooking relevant points during execution;
Execute JS Proxy Object wrapping relevant access points and APIs (for example, this approach can be implemented with any live website). Various example designs and pre-requisites can be implemented to ensure security and privacy. For example, the prerequisites can include that the hooking JS tag is the first to execute on the page, or is included inline in the HTML code of the main page (and not as an external downloaded JS resource etc.). In further example, this approach can also be implemented in an on-line setting in which only JS as part of the website is available (e.g., the execution environment is not entirely controlled). According to various embodiments, being first to load ensures that malicious scripts or even poor code does not mask its operation, concealing potential vulnerabilities, data leakage, or attacks. In further embodiments, the system leverages native browser capabilities for proxy execution (for example the known FIREFOX browser includes a proxy object that can be defined to handle any operation specifying an access point and/or interaction with an API), and defines novel proxy architecture to ensure privacy and security for any API or JS execution,
   Further, delivery of this code can be done server-side (if not by Browser Extension). In one example, the system provides a browser extension that is configured to protect functions, properties, and objects that can otherwise be exploited to construct attacks. In one embodiment, browser functions are wrapped with replacement versions that allow injection of a policy. For example, a simple policy can enforce the number of times data can be requested (e.g., or any functionality can be called) and get a valid result. When that threshold is exceeded the policy requires/returns an error or returns empty values. Another example is allow/deny execution/output based on the identity of the caller code origin. In various embodiments, the ability to control the execution environment enables hook/proxy access that remains hidden, and provides a more secure level than a JS Proxy object in the same execution context of the page.

The various methodologies above can be generated using virtual machines and images, operating system images, and/or images of builds of various browsers, among other options. Once the environment is properly set up, for example with browser extensions, configurations, etc., monitoring and/or control of third party scripts can be managed.

In various embodiments, the system is configured to execute dynamic analysis on JS requests and/or DOM access, in further embodiments the system can also execute static analysis on any script/process to map out code locations around access to said areas. In some embodiments, the system is configured to run a security/privacy audit on the behavior of any script, and in further example, various embodiments can employ the security/privacy audit when source code review or revelation is not available or possible. Unlike many conventional systems that do resolve security and/or privacy issues for JS script dynamically and statically, various embodiments described herein ensure an improved level of security and privacy. To the best of the inventors' knowledge there are no known automated tools for ensuring or gaining confidence in a third party JS code is not accessing APIs/data the site owner does not want to allow (for example form data containing users PII, such as email credit card numbers etc.). In the current environment, most JS providers obfuscate their code and refuse to provide details on execution. The result is a forced trust relationship that requires trust in the JS provider to not act maliciously or to not accidentally create vulnerabilities or leaks. According to various embodiments described herein, the management system can eliminate the trust requirement by providing technological implementation to evaluate any execution, and verify proper functionality.

According to one embodiment, the system is configured to enable a client website to decide to validate an iteration of a script or browser that has zero access to check out forms (e.g., no “data scraping”), for example by a JS, by executing the browser and any associated operations in a test phase. If the system confirms that the script or browser passes the test phase (e.g., no logged scraping, no requests for inappropriate data, etc.), the system is configured to provide a “trust stamp” on the version of the script and/or browser. In one example, the version can be verified using a content hash, among other options. On subsequent review, if the script's hash matches a validated hash then the execution properties of the subsequently reviewed script and/or browser is known to be valid. Various browsers have functions embedded to handle securely accessing resources. For example, FIREFOX employs Subresource Integrity “SRI” to validate a secure hash on an accessed resource. The browser then can verify that resources they fetch (for example, from a content delivery network “CDN”) are delivered without unexpected manipulation. According to various embodiments, all major browsers that are available provide utilities that can be used to secure execution, for example, when analyzing validated operation with associated trust indicia. In another example, a hash mechanism can be employed as part of an inline script to secure operation. Content Security Policy (“CSP”) inline script can employ a sha-256 hash to secure options.

According to some embodiments, the system is configured to execute loaded scripts via proxy processes and/or a proxy layer in a test environment. The system can monitor all requests and areas accessed in the test environment. Logging of the scripts accessed and utilization can be analyzed to confirm security and/or privacy is respected. In one example, an administrative user can load scripts into the test environment, and the system generates a report on the areas being accessed, and the type of access being performed by each script. The report can be evaluated to ensure security and privacy requirements are met. Once validated, the report can then be presented with a “signed proof” of being data access safe (as defined by the administrative user). In further embodiments, the combination of a signed proof and cryptographic hash on any script provides assurance to installers or system administrators that a specific script being run within a browser is verified secure and privacy (e.g., based on the requirements defined in testing).

Further embodiments can include additional functions that can be executed securely wherein the functions imposed constraint on execution. Some embodiments can include defining scripts that are not allowed to call performance-expensive APIs (e.g., can be determined on estimated, anticipated utilization, and/or predefined lists, among other options), defining scripts that are not allowed to call other APIs (e.g., blacklisted sensitive APIs, APIs with potential security issues, etc.), and defining a script that cannot exceed using some % of CPU resources when loading a page, among other options.

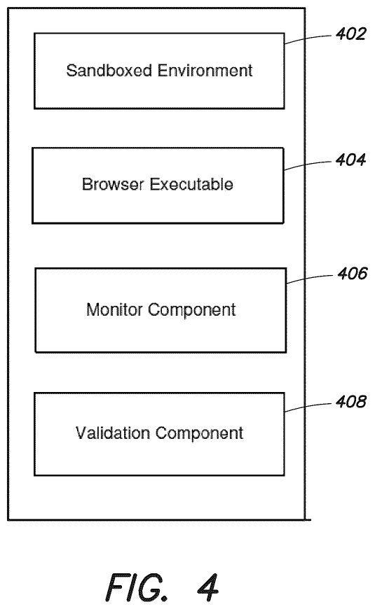

FIG. 4 is an example block diagram of a system for validating browser and/or script execution. According to some embodiments, the system can instantiate a plurality of components each configured to perform functions disclosure herein. In other embodiments, the system can perform the described functions without executing the various components.

According to one embodiment, the system 400 is configured to define a sandboxed execution environment 402. A sandboxed execution environment describes a security mechanism used to limit operations and/or execution of application and/or functions, and can also be used to isolate operating systems from other code, among other options. In some implementations, the system establishes a sandboxed environment to control operations of browser functionality and/or plugins, APIs, extensions, etc., of the browser application (e.g., 404 browser executable). For example, the system can include a browser application that is executed within the sandboxed environment.

Further embodiments can include a monitor component 406 that is configured to identify functions, call, etc., being executed by the browser application. The monitor component can be integrated into the sandboxed environment and form a proxy layer that manages various function calls and/or proxied hooks into the various functions, APIs, etc. called by the browser. For example, the monitor component can identify, track, and log targets of browser operations. The various targets can be evaluated based on potential data privacy issues, security threat, or vulnerability. In some embodiments, the monitor component can be used to build lists of function targets that the system can prevent from being called. For example, any function or target on form data can be suspect and closely monitored. Other examples include any API/function that directly or indirectly allows extraction of user-entered data (e.g., PII, financial data etc.). Additional examples included operations for browser/user fingerprinting and related APIs (these vary, but include webgl, webrtc, screen information, etc.). Still other examples include functions that are known to be costly (computationally) for site performance speed and user experience. In some embodiments,

Various conventional approaches fail to identify masked or concealed functions, and fail to identify suspect activity that occurs at or based on a request target. Various embodiments are configured to identify and/or prevent attempts to conceal data access or suspect activity based on proxied execution and/or by employing modified functions having safe/known behavior. In some examples the system can employ modified functions that take the place of unsecured versions. For example, in a test environment, function calls or other executables can be rewritten as proxied operations, and the proxied version can be monitored and report on its own operation. In another example, a proxy layer or wrapper object can operate as a gateway on functions, calls, requests, etc., passing through only ones that are valid, have appropriate targets, etc., and block or report on any operations with suspect or malicious targets. The proxied operations can also be configured to identify detection operations, including for example, operations configured to learn information on an execution environment. Some attacks are staged to discover then exploit, and can be separated in time and across multiple executables, plugins, extensions, etc. By identifying and blocking discovery operation, the system can improve over security approaches.

In some embodiments, the system can include a validation component 108 configured to determine that a function is secure and/or that an application is based on a known version. For example, the system can validate that a browser application is a known version via a secured hash. In other examples, the system can validate various substitute functions and/or functionality to ensure that secured operation cannot be circumvented. For example, the system can be configured to check if a certain JS function is similar to a native version supplied by the browser or detected modification by some JS code to add/remove logic. In other examples, “malicious” code can decide that a function that writes text into a form field (e.g., email, cc number) also triggers sending a network request with this data somewhere. The system is configured to detect and prevent the network request.

According to one embodiment, the system is configured to validate operation via these a proxy layer or hooking all of the function controls so that whenever is requested (e.g., outside resources or data), the system is configured to track what is requested and what operations are done. In this context, the system can identify any suspect, invalid, and improper activity. For example, data access not needed in the API context would be flagged invalid. In addition, the system is configured to allow users to define specific operations or accesses that they want to not allow. The system can monitor for some known subset of functions and augment that subset with user defined targets, so that the system does not need to compile a full report of everything that is being accessed-such an undertaking can be computationally prohibitive.

For example, a user can specify on the system that they want to prevent anything that has functions for, or like, DOM extraction, prevent any function that extracts information from forms, etc. In some embodiments, the system is configured to report on operations, functions, or accesses specified by the user (e.g., form access, API calls to form data, etc.).

In various embodiments, the system is configured to conceal proxied operations to ensure that scripts, codes, or functions is not attempting to cheat the system. For example, if a script can detect it is being monitored, the script can be coded with monitored behavior settings that appear valid, safe, and/or to respect data privacy, while having other functionality that is only executed in unmonitored environments. It is realized that not every user interaction leads to all the code being executed, not all the code need be executed in various conditions. Various embodiments can be configured to resolve this issue based on fuzzing. The target in fuzzing is to execute as many scenarios and code paths, including at random, as possible. Again, the system permits the user to define such scenarios that they believe are important or likely (e.g., ensure coverage of main flows-like the checkout flow or filling out the form). In addition, random fuzzing tests can be added to any default set of tests, any user specified test, etc. In conjunction with scenario based execution, the system can integrate static code analysis.

In various embodiment, the system is configured to control or manage the browser so that execution can be monitored and/or verified. In one example, the system provides a recompiled browser that integrates changes on the native level. In these settings, the system can guaranty that a given JavaScript has no direct way of figuring out whether any function is not native or hooked. When the execution environment is not managed or control such guarantees are more difficult.

### Example Architecture: Real-Time Control and Governance

According to another aspect, an extension of the approaches described above can be integrated into an online system. For example, the approaches above can also be modeled as a real-time permission and access control system. According to some embodiments, the system can be configured to execute a subset of “hooks” or “proxies,” where the subset is known and verified to be safe to run for a live production website. Based on execution of the real-time permission and access control, various embodiments are configured to provide real time alerts and restrictions on third party JS code.

As has been demonstrated, JavaScript can be used to mount cache attacks and other malicious operations. Some approaches are available to circumvent these attacks. However, many conventional implementations focus on permissions and access and do not account for limiting execution or securing execution on other basis (e.g., based on performance limitations, among other options). Further conventional implementations describe a browser extension level as a proof of concept. Owing to the implementation, such an approach is not optimized or in many cases not capable for use in offline analysis and does not provide security at a browser native level layer. The inventors have realized that conventional implementation does not provide for securely concealing proxied execution. For example, known conventional approaches do not try to hide themselves very well. The result is that conventional proxy approaches can easily be detected and circumvented.

In some embodiments, the system executes a real-time control module configured to provide enhanced security in real-time. In further embodiments, the real-time JS control module yields additional security and optimization in further contexts: browser clients often complain about needing to include many third party JS scripts, when a few of them access the same data and APIs (but do slightly with different processing and need their own custom code to run on the site). The impact for this requirement comes both in terms of a JS performance impact, and an impact on data access management. Many conventional approaches seek to resolve this issue by pushing JS providers into some sort of consolidation, where JS providers are limited based on the fact that they are collecting the same data to take the needed data from one or more specified sources. The inventors have realized that this approach is often not possible and/or not feasible.

Thus, various embodiments of the system couple a caching layer with the JS proxy layer to enable JS script to take data from the cache rather than forcing an arbitrary consolidation that does not work in many conventional approaches. In one embodiment, the system implements a proxy for JS and to provide caching. For example, the system executes scripts to manage an option of caching on a first request, thus allowing the system to be more efficient. In one example, the system cache enables saving resources on costly browser APIs that would normally be called over and over. In further embodiments, the system is configured to optimize performance by accessing some data in the most efficient way possible (for example, using background threads to handle common data requests while preserving the ability of a main thread (e.g., UI) to continue to run without blocking or slowing). In one example, the system can employ WebWorker threads to more efficiently provide data access in a cache layer.

In still other embodiments, the system can implement full blown JS governance. For example, the system can be configured to map out which script (vendor) is trying to access which data. According to one embodiment, the system can be configured to perform a stack trace analysis on the intercepted function call-site. For example, the system can include logic to locate interesting calling scripts vs. generic script layers (like jQuery).

In further embodiments, the system can use the knowledge of script and data access to manage all such requests according to a system defined budget. In various examples, the system can be configured to provide “budget” controls for APIs or data, etc. The budget can define access to data such that caches data use is maximized across APIs, scripts, etc. Further, the budget can limit and/or allocate processing across various tasks, so no vendor implementation overwhelms any environment. In some embodiments,

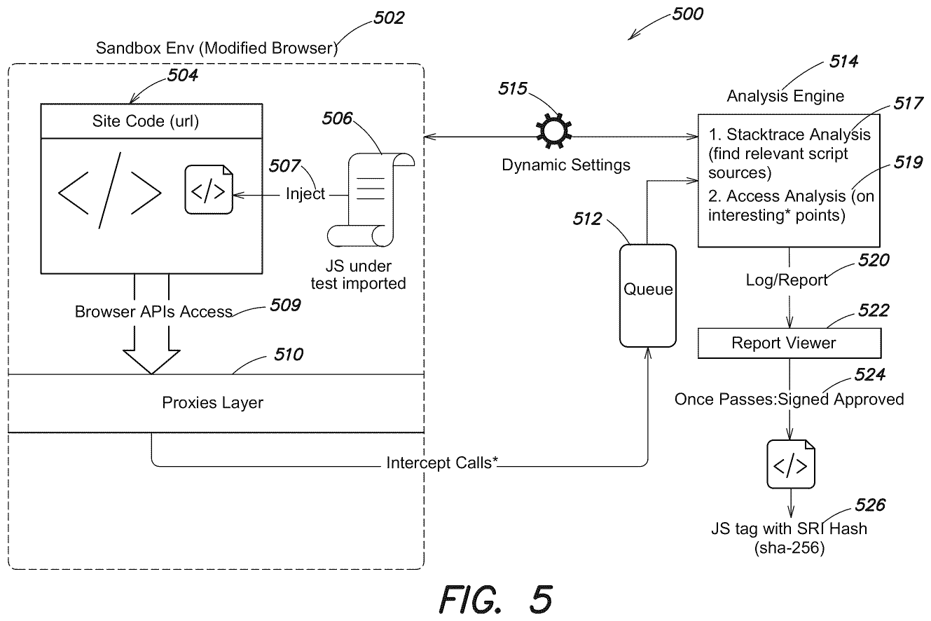

FIG. 5 is a block diagram of an example system and flow for secure execution of browser functions and respective processes. According to one embodiment, the system 500 can include a sandbox environment 502 for securely executing browser code and/or scripts (e.g., 506). According to some embodiments, site code can be accessed from within the sandbox environment to enable analysis of operations under test. For example, a JavaScript 506 can be imported into the environment and injected at 507 into the site code to evaluate its operation. During operation any calls, requests, and/or operations can be monitored.

According to one embodiment, the sandbox environment 502 is configured to monitor any browser API access that occurs (e.g., at 509). Such access can be managed via proxy layer 510 configured to intercept requests, calls, communication, etc. For example, the proxy layer 510 can be configured to manage JS. DOM, network operation so that the proxy layer can identify valid versus invalid access or requests and respond accordingly.

According to one embodiment, the proxy layer 510 is configured to intercept calls originating in the browser or APIs and feed those calls into a queue 512 for analysis. According to some embodiments, the system can include an analysis engine configured to validate or reject operations performed by code under test based on any dynamic settings 515 or known attack/invalid operations and/or targets. Various dynamic settings can be set on the system to permit analysis of various operations. System users can set specific dynamic settings according to operations and their known parameters. For example, the system users can define information on data access, specifying what requests or valid and what requests target invalid or inappropriate information. According to some embodiments, the dynamic settings can include target in handler information which can be analyzed by the analysis engine to validate operation (e.g., accessing known data source, accessing known functionality, etc.).

According to some embodiments, the analysis engine 514 is configured to analyze intercepted calls in queue 512 by executing stack trace analysis on relevant operations, data sources, data targets, etc. For example, at 517 the analysis engine can perform stack trace analysis to find relevant script sources in the script under test (e.g. 506). At 519 the analysis engine can execute analysis on access of the respective calls in queue 512. According to some embodiments, access analysis is performed on interesting points resulting or that are the targets of any script execution, function, call etc., Interesting points can be specified in the dynamic settings or can be based on known malicious targets for on known good targets, among other options.

Further examples of dynamic settings include limiting/focusing the scope of the audit functions. In various contexts, the burden or computation effort for monitoring everything being done is significant. Targeting the monitoring to sets of functions requested by any JS or APIs improves operations. In the event of suspect or dangerous activity, the system can expand monitoring to include additional functions to monitor, expand stack trace analysis on additional functions, etc., as part of the dynamic settings. In some embodiments, the dynamic settings include triggering custom access checks that the system does not execute by default or as pre-configured checks. In other examples, the user of the system can plug in their own module that detects something important to their space not covered by default or with pre-configured options. Still other options for dynamic setting include updates to the conditions and/or the parameters that trigger access warning/errors in the final report, updates to fuzzing patterns (e.g., expand parameters), trigger recording and replay of scripting user interactions with the page to elicit execution paths from the JS code under audit or analysis.

According to some embodiments, the analysis engine 514 is configured to log and/or report on the operations executed by any of the intercepted calls in queue 512. For example, at 520 the analysis engine generates a log or report on the intercepted calls any analysis done by stack trace, including relevant script sources, any access analysis including any interesting target points, and can include information on blocked functions, blocked access, among other options.

According to some embodiments, the analysis engine 514 can be configured to validate a script under test (e.g., 506) automatically based on the analysis engine not generating any indicia of malicious or bad action. In further embodiments, the analysis log can be presented the report viewer 522 for validation via system user. According to some embodiments, the report viewer can highlight suspect activity, including suspect access, suspect operations, suspect discovery attempts, etc. If a script under analysis passes the validation test, the system can be configured to generate a signature on the original script under test at 524. The system can integrate a JS tag within SRI hash of the original script under test for subsequent use in validating browser operation.

In some embodiments, system 500 can be configured to operate as an auditing system. The auditing system can evaluate candidate scripts, functions, etc. in the sandboxed environment and create tags for validated scripts. In some embodiments, the system 500 is configurable for what parameters and what calls to evaluate. For example, the dynamic settings can be set on a script by script basis allowing custom analysis for each script, and can also be configured by system users.

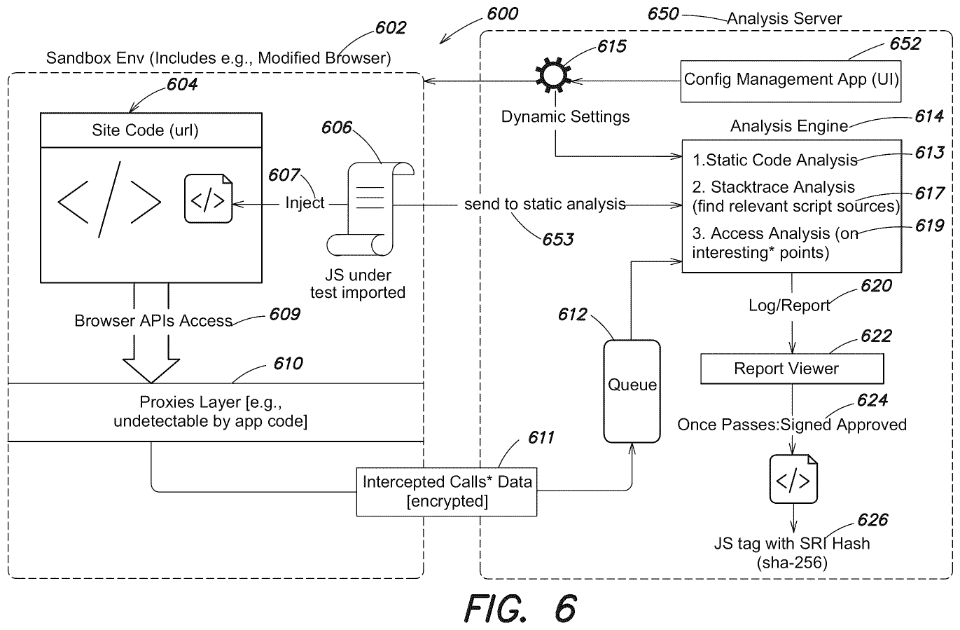

FIG. 6 is a block diagram of an example system and flow for secure execution of browser functions and respective processes. According to one embodiment, the system 600 can include a sandbox environment 602 for securely executing browser code and/or script that operates in conjunction with an analysis server 650. The analysis server can include configuration setting and functions to manage secure execution, analysis, and monitoring of browser functionality. According to one embodiment. The analysis service can include a configuration management application and/or user interface (e.g., 652) to access or establish settings for operation, including for example, dynamic settings 615.

According to some embodiments, site code can be accessed from within the sandbox environment to enable analysis of operations under test. For example, a script 606 (e.g., JS) can be imported into the environment and injected at 607 into the site code to evaluate its operation. During operation any calls, requests, and/or operations can be monitored. According to some embodiments, the sandboxed environment 602 can include a customized browser to ensure that operation occurs securely. In other embodiments, the system can manage and/or monitor operations of conventional browsers, as discussed herein, improving their security and operation.

According to one embodiment, the sandbox environment 602 is configured to monitor any browser API access that occurs (e.g., at 609). Such access can be managed via proxy layer 610 configured to intercept requests, calls, communication, etc. For example, the proxy layer 610 can be configured to manage JS, DOM, network operation so that the proxy layer can identify valid versus invalid access or requests and respond accordingly.

According to one embodiment, the proxy layer 610 is configured to intercept calls originating in the browser or APIs and feed those calls (e.g., at 611) into a queue 612 for analysis. In some embodiments, the intercepted calls can be passed to the analysis server 650 and into any queue in encrypted formats to ensure secure operation.

According to some embodiments, the system can include an analysis engine 614 configured to validate or reject operations performed by code under test based on any dynamic settings 615, statis static analysis 613, and/or known attack/invalid operations and/or targets. In static analysis the purpose is to scan the code and figure out which API calls and Objects are potentially accessed from the code. For example, looking at constructs that end up calling window.X or navigator.Y (X and Y being functions or objects, such as window.screen of navigator.userAgent).

Various dynamic settings can be set on the system to permit analysis of various operations. System users can set specific dynamic settings 615 according to operations and their known parameters. For example, the system users can define information on data access, specifying what requests are valid and what requests target invalid or inappropriate information. In various embodiment, the dynamic settings can be used to limit/target the scope of the analysis for time/performance/priority reasons and/or extending the static analysis functionality with what the user cares about (for example, specifying objects/functions to search access for that are not inside window or navigator that are also interesting to them, among other options). According to some embodiments, the dynamic settings can include targets and handler information which can be analyzed by the analysis engine to validate operation (e.g., accessing known data source, accessing known functionality, attempt vulnerability access, attempted vulnerability functionality, etc.).

According to some embodiments, the analysis engine 614 is configured to analyze intercepted calls in queue 612 by executing stack trace analysis on relevant operations, data sources, data targets, etc. For example, at 617 the analysis engine can perform stack trace analysis to find relevant script sources in the script under test (e.g. 606). At 619 the analysis engine can execute analysis on access of the respective calls in queue 612. As part of the operations performed by the analysis engine 614, static analysis can be executed at 613, based on communication of the script under test (e.g., 606) at 653 to the analysis server 650 and/or engine 614.

According to some embodiments, access analysis is performed on interesting access points resulting or that are the targets of any script execution, function, call etc. Interesting points can be specified in the dynamic settings or can be based on known malicious targets, or on known good targets, among other options.

According to some embodiments, the analysis engine 614 is configured to log and/or report on the operations executed by any of the intercepted calls in queue 612. For example, at 620 the analysis engine generates a log or report on the intercepted calls any analysis done by stack trace, including relevant script sources, any access analysis including any interesting target points, and can include information on blocked functions, blocked access, among other options.

According to some embodiments, the analysis engine 614 can be configured to validate a script under test (e.g., 606) automatically based on the analysis engine not generating any indicia of malicious or bad action. In further embodiments, the analysis log can be presented the report viewer 622 for validation via system user. According to some embodiments, the report viewer can highlight suspect activity, including suspect access, suspect operations, suspect discovery attempts, etc. If a script under analysis passes the validation test, the system can be configured to generate a signature on the original script under test at 624. The system can integrate a JS tag within SRI hash of the original script under test for subsequent use in validating browser operation.

In some embodiments, system 600 can be configured to operate as an auditing system. The auditing system can evaluate candidate scripts, functions, etc. in the sandboxed environment and create tags for validated scripts. In some embodiments, the system 600 is configurable for what parameters and what calls to evaluate. For example, the dynamic settings can be set on a script by script basis allowing custom analysis for each script, and can also be configured by system users. In still other embodiments, the system can operate in a validation mode, where scripts having tags that include hash values can be confirmed as safe for execution, installation, etc. In some embodiments, the system can include monitoring processes, including those that can be separately accessed, installed, etc. an execution location (e.g., user device, user environment, audit environment, audit device, etc.) to continuously, periodically, a-periodically, monitor that a given script matches its validated signature information.

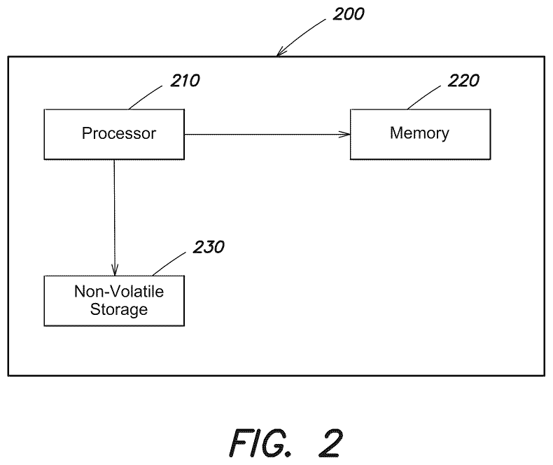

Additionally, an illustrative implementation of a special purpose computer system 200 that may be specially programmed to be used in connection with any of the embodiments of the disclosure provided herein is shown in FIG. 2. The computer system 200 may include one or more processors 210 and one or more articles of manufacture that comprise non-transitory computer-readable storage media (e.g., memory 220 and one or more non-volatile storage media 230). The processor 210 may control writing data to and reading data from the memory 220 and the non-volatile storage device 230 in any suitable manner. To perform any of the functionality described herein (e.g., secure execution, proxied execution, caching functions, etc.), the processor 210 may execute one or more processor-executable instructions stored in one or more non-transitory computer-readable storage media (e.g., the memory 220), which may serve as non-transitory computer-readable storage media storing processor-executable instructions for execution by the processor 210.

The terms “program” or “software” or “app” are used herein in a generic sense to refer to any type of computer code or set of processor-executable instructions that can be employed to program a computer or other processor to implement various aspects of embodiments as discussed above. Additionally, it should be appreciated that according to one aspect, one or more computer programs that when executed perform methods of the disclosure provided herein need not reside on a single computer or processor, but may be distributed in a modular fashion among different computers or processors to implement various aspects of the disclosure provided herein.

Processor-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

Also, data structures may be stored in one or more non-transitory computer-readable storage media in any suitable form. For simplicity of illustration, data structures may be shown to have fields that are related through location in the data structure. Such relationships may likewise be achieved by assigning storage for the fields with locations in a non-transitory computer-readable medium that convey relationship between the fields. However, any suitable mechanism may be used to establish relationships among information in fields of a data structure, including through the use of pointers, tags or other mechanisms that establish relationships among data elements.

Also, various inventive concepts may be embodied as one or more processes, of which examples have been provided. The acts performed as part of each process may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, and/or ordinary meanings of the defined terms. As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements.

This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The phrase “and/or.” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

Use of ordinal terms such as “first,” “second,” “third,” etc., in the claims to modify a claim element does not by itself connote any priority, precedence, or order of one claim element over another or the temporal order in which acts of a method are performed. Such terms are used merely as labels to distinguish one claim element having a certain name from another element having a same name (but for use of the ordinal term).

The phraseology and terminology used herein is for the purpose of description and should not be regarded as limiting. The use of “including,” “comprising,” “having,” “containing”, “involving”, and variations thereof, is meant to encompass the items listed thereafter and additional items.

Having described several embodiments of the techniques described herein in detail, various modifications, and improvements will readily occur to those skilled in the art. Such modifications and improvements are intended to be within the spirit and scope of the disclosure. Accordingly, the foregoing description is by way of example only, and is not intended as limiting. The techniques are limited only as defined by the following claims and the equivalents thereto.

What is claimed:

1. A system for managing script execution by a browser, the system comprising:
at least one processor;
a memory operatively coupled to the at least one processor;
the at least one processor when executing configured to:
instantiate a browser session to include a proxy layer configured to manage interaction with the browser and secured functions called by third party operations, wherein the secured functions are configured to run as part of a website's code presented in the browser;
monitor execution of the secured functions;
verify valid execution of the secured functions;
prevent execution of the secured functions by the browser or browser functionality responsive to failed verification;
permit execution of the secured functions by the browser or browser functionality responsive to verification.

2. The system of claim 1, wherein the at least one processor is configured to instantiate a cache layer to manage resource requests made by the browser, any script executed by the browser, and any application programming interface.

3. The system of claim 2, wherein the at least one processor is further configured to allocate cache resources based on a mapping of the requests made by the browser, any script executed by the browser, and any application programming interface to the resources.

4. The system of claim 2, wherein the at least one processor is further configured to allocate the cache resources based on a mapping of the requests made by the browser and a system defined budget for the mapped resources.

5. The system of claim 1, wherein the at least one processor is configured to limit execution of the browser or browser functionality to the secured functions.

6. The system of claim 1 wherein the at least one process is configured to access policy constraints defining parameters of the valid execution.

7. The system of claim 6, wherein the parameters are defined by at least one of default constraints, user specified constraints, budgeted constraints, or certification of validity constraints.

8. The system of claim 1, wherein the at least one processor is configured to execute inline code or script tags upon accessing a website to instantiate the proxy layer.

9. The system of claim 8, wherein the proxy layer includes a set of proxy objects configured to manage execution of third party function requests by the browser.

10. The system of claim 9, wherein the third party function requests include at least one of javascript request, document object model (DOM) request, or application programming interface (API) requests.

11. The system of claim 9, wherein the at least one processor is configured to access any one or more of a default specification of the set of proxy objects, a user defined specification of the set of proxy objects, or an enhanced verification specification of the set of proxy objects.

12. The system of claim 9, wherein the at least one processor is configured to trigger enhanced verification responsive to identifying unexpected operation or unexpected access.

13. The system of claim 12, wherein the at least one processor is configured to access an enhanced verification specification defining at least one of additional proxy objects, updated functionality for any one or combination of respective ones of the set of proxy objects, or additional analysis of access requests.

14. The system of claim 1, wherein the at least one processor is configured to validate a third party function based on a validity signature of the third party function.

15. The system of claim 14, wherein the at least one processor is configured to allow or deny execution of the third party function in response to validity analysis of the signature.

16. A computer implemented method for managing script execution by a browser, the method comprising:
instantiating, by at least one processor, a browser session, the act of instantiating including establishing a proxy layer configured to manage interaction with the browser and secured functions called by third party operations, wherein the secured functions are configured to run as part of a website's code presented in the browser;
monitoring, by the at least one processor, execution of the secured functions;
verifying, by the at least one processor, valid execution of the secured functions;
preventing, by the at least one processor, execution of the secured functions by the browser or browser functionality responsive to failed verification; and
permitting, by the at least one processor, execution of the secured functions by the browser or browser functionality responsive to verification.

17. The method of claim 16, wherein the method further comprises executing, by the at least one processor, inline code or script tags upon accessing a website to instantiate the proxy layer.

18. The method of claim 17, wherein the method further comprises generating, by the at least one processor, a set of proxy objects included in the proxy layer, wherein the proxy objects are configured to manage execution of third party function requests by the browser.

19. The method of claim 18, wherein the third party function requests include at least one of javascript request, document object model (DOM) request, or application programming interface (API) requests, and method further comprises managing, by the at least one processor, execution of the at least one of javascript requests, document object model (DOM) request, or application programming interface (API) requests through respective poxy objects.

20. The method of claim 19, wherein the method further comprises accessing, by the at least one processor, any one or more of a default specification of the set of proxy objects, a user defined specification of the set of proxy objects, or an enhanced verification specification of the set of proxy objects.
